(19) United States
(12) Patent Application Publication
(10) Pub. No.: US 2019/0301661 A1
(43) Pub. Date: Oct. 3, 2019

(54) Vacuum jacketed tube

(71) Applicant: Advanced Ion Beam Technology, Inc., Hsinchu City (TW)

(72) Inventors: Yu-Lin Chang, Tainan (TW); Chien-Cheng Kuo, Tainan (TW); Yu-Ho Ni, Tainan (TW); Chun-Chieh Lin, Tainan (TW)

(21) Appl. No.: 16/369,479

(22) Filed: Mar. 29, 2019

Related U.S. Application Data
(60) Provisional application No. 62/650,518, filed on Mar. 30, 2018.

(51) Int. Cl. F16L 59/065

(52) U.S. Cl. CPC F16L 59/065

(57) ABSTRACT

The proposed vacuum jacketed tube may deliver the high/low temperature fluid with less temperature-transfer, especially may delivery high/low temperature fluid through a flexible structure. The vacuum jacketed tube includes a tubular structure surrounding a pipe wherein the fluid is delivered therethrough. Also, the space between the tubular structure and the pipe may be vacuumed. Therefore, the heat transferred into and/or away the fluid may be minimized, especially if the tubular structure and the pipe is separated by at least one thermal insulator or is separated mutually. Moreover, the vacuum jacketed tube may be mechanically connected to the source/destination of the delivered fluid, even other vacuum jacketed tube, through the bellows and/or the rotary joint. Besides, the pipe may be surrounded by a Teflon bellows and the tubular structure may be surrounded by a steel bellows, so as to further reduce the heat transferred into/away the fluid delivered inside the pipe.

### FIELD OF THE INVENTION

The present invention relates to a vacuum jacketed tube that may deliver a high temperature fluid or a low temperature fluid with less temperature-transfer along a flexible (i.e., non-fixed) delivering path. In this invention, a tubular structure surrounds a pipe where the fluid is delivered therewithin and the space therebetween is vacuumed. In this way, the heat transfer between the delivered fluid and the external may be minimized.

### BACKGROUND OF THE INVENTION

In the semiconductor industry, LCD industry, LED industry, or other related industries, the delivery of a high or low temperature fluid is indispensable. For example, the factory service has to deliver liquid nitrogen from a gas tank outside the factory to the machines inside the factory. For example, in some applications, such as high or low temperature ion implantation, even PVD, CVD, PECVD and/or epitaxial, a heating fluid or a cooling fluid has to be delivered through the chuck holding the wafer to control the wafer temperature during the process period. Besides, the chuck and the wafer are usually positioned in a vacuum environment during the processing period, hence, the delivery of the high or low temperature fluid may be further difficult because pipe(s) for delivering such a fluid may be broken or worn-out and in consequence may induce a leakage of the fluid. Particularly, in some applications such as the ion implantation when the chuck holding the wafer is moving, twisting and/or tilting with respect to the ion beam during the process period, a delivering path of the fluid has to accommodate the dynamic movements of the chuck, which means it needs to be adaptable to the movements of the chuck for continuously delivering the fluid without leakage. Similarly, the flexible and adaptable fluid delivering path is especially beneficial in situations that the connection between the factory fluid supply pipelines and the inputting/outputting port of the machine is winding or that the relative geometrical relation between the neighboring machines has to be re-arranged.

Some known technologies use multiple sectors of rigid pipe connecting altogether to deliver a high or low temperature fluid. The multiple connected rigid pipe sectors may be extendable along different directions respectively so as to deliver the fluid adaptably to the movements to the intended destination, such as the chuck inside the process chamber. However, such combination is complicated and less flexible to meet the required variation of the fluid delivering path. Specific, if the intended destination is rotated around the axis of the rigid pipe sector(s) and if the rigid pipe sector(s) is damaged by the extremely high or low temperature of the delivered fluid. Some known technologies coat the insulator and/or the foam at the sidewall of the pipe where the fluid is delivered through their inner space so that the heat transfer between the fluid and the external environment may be decreased. Particularly, the elastic property of the insulator and/or the foam allows the pipes/pipes being continuously and fully surrounded by the insulator and/or the foam even they are bended and/or re-configured with different shapes. However, to effectively minimize the heat transfer, the required thickness of the insulator and/or the foam may be too large to be practically applied if the temperature between the delivered fluid and the external environment is larger and/or lower enough. Besides, while the temperature of the delivered fluid is lower and/or higher enough, the used insulator/foam may be broken, worn and/or degraded which unavoidably increases the heat-lose and/or temperature-transfer between the delivered fluid and the external environment, especially if the insulator/foam coated at the pipe is dynamically moved to support some applications, such as the low temperature ion implantation and the delivery of the liquid nitrogen from the fixed tank into different machines positioned on different positions.

Accordingly, there is a need to provide a new approach which may deliver fluid with less temperature transfer, especially if the delivering path is changed (such as bended or twisted) during the delivering period, also if the temperature of the delivered fluid is higher and/or lower enough so that the materials/devices conventionally used to reduce the heat transfer may be significantly damaged.

### SUMMARY OF THE INVENTION

The problems of the prior art are overcome by the vacuum jacketed tube mechanically connected to both the fluid source and the fluid destination such that the fluid may be delivered from the fluid source through the vacuum jacketed tube to the fluid destination. The vacuum jacketed tube may be used to deliver liquid or gas, such as the liquid nitrogen, the cooling gas or the process gas (such as SiH4, AsH3, HBr, BCL3, etc.), also may be used in various delivery scenarios. For example, the vacuum jacketed tube could be applied in the delivery of any cooling liquid from a chiller to the chamber inside a machine, and also could be applied in the delivery of liquid nitrogen from a gas tank outside a factory to designated machines within the factory.

Essentially, the proposed vacuum jacketed tube has a tubular structure surrounding the pipe which directly delivers fluid through its inner space. Besides, the space between the tubular structure and the pipe is vented out to be at least nearly vacuum so that heat could only be transferred between the pipe and the tubular structure through heat radiation. In this way, temperature of fluid delivered inside the pipe may be kept within a predetermined finite range during the delivery process. Both the details of the pipe and the tubular structure are not limited. For example, the pipe may include one or more conduits configured to deliver different fluids respectively and/or deliver the same fluid along two opposite directions, no matter the pipe is a combination of these conduits or the pipe is a tubular pipe surrounding these conduits. For example, both the tubular structure and the pipe may be made of flexible material and may be a flexible structure, such that the vacuum jacketed tube is not a rigid structure and is adaptive to the motion and/or deformation of the destination and/or the source where the fluid is delivered into and/or from. For example, stainless steel, steel, iron, aluminum, copper, Teflon, Polytetrafluoroethylene, plastic, rubber, thermal insulator, even other material with finite elasticity, may be used to form the tubular structure. For example, Teflon, Polytetrafluoroethylene, plastic, rubber, thermal insulator, even other material with finite elasticity, may be used to form the pipe. For example, at least a special portion of the tubular structure and/or the pipe may have a bellows-like shape (or viewed as may be a bellows in this special portion).

One main feature of the proposed vacuum jacketed tube is that an elastic structure mechanically contacts with the tubular structure along the axial direction of the vacuum jacketed tube and surrounding the pipe. Therefore, if the fluid source and/or destination is not statically stationary during the delivering period, the elastic structure may provide be deformed to adapt the motion and/or deformation of the fluid source/destination. Even if the vacuum jacketed tube is affected by unexpected collision or other external factors, the elastic structure may be deformed to keep both the tubular structure and the pipe be less affected. For example, the elastic structure may be a bellows mechanically contacted with the tubular structure. Thus, the vacuum jacketed tube may be extended, compressed and/or bent to meet the changed relative geometric relation between the fluid source and the fluid destination. For example, the elastic structure may be a rotary joint mechanically contacted with the tubular structure. Thus, even if the fluid source and/or destination is rotated around the axis of the vacuum jacketed tube, the rotary joint may absorb the relative rotation and then keep the vacuumed space between the tubular structure and the pipe is not broken. Besides, to further blocking the heat exchange between the fluid delivered through the pipe and the external environment, a thermal-isolated insulate cover may be positioned outside and surround the tubular structure, because heat must be transferred through the thermal-isolated insulate cover before being transferring from the delivered fluid into the external environment, and vice versa. For example, the thermal-isolated insulate cover may be aluminum tape, aluminum foil tape, glass fiber, thermal casing or other equivalents.

Another main feature of the proposed vacuum jacketed tube is that a set of bellows surrounds at least one of the pipe and the tubular structure. Therefore, the heat transfer between the delivered fluid and the external environment outside the vacuum jacketed tube may be further decreased. For example, an inner bellows made of Teflon, plastic, rubber or other thermal insulator may surround the pipe, at least a portion of the pipe. Thus, the probability of transferring heat into or away the delivered fluid inside the pipe may be reduced due to the low thermal conductivity of these materials. For example, an outer bellows made of stainless steel, iron, aluminum, copper, other metal, Teflon, Polytetrafluoroethylene, plastic, rubber or thermal insulator may surround the tubular structure, at least a portion of the tubular structure. Thus, not only the structural strength of the vacuum jacketed tube may be enhanced, but also the probability of transferring heat into or away the delivered fluid inside the pipe may be reduced. Similarly, to further blocking the heat exchange between the fluid delivered through the pipe and the external environment, a thermal-isolated insulate cover may be positioned outside and surround the outer bellows, because heat must be transferred through the thermal-isolated insulate cover before being transferring from the delivered fluid into the external environment, and vice versa. For example, the thermal-isolated insulate cover may be aluminum tape, aluminum foil tape, glass fiber, thermal casing or other equivalents.

Furthermore, two or more vacuum jacketed tube may be mechanically connected so that the fluid may be delivered among different vacuum jacketed tube. To minimize the leakage of the delivered fluid and/or the degradation of the vacuum degree, one option is use a connector to connect two or more vacuum jacketed tube. The connector has a body enclosing an empty inner space and some terminals on the body where different vacuum jacketed tubes are mechanically connected to respectively. As usual, the connector is a connector may firmly hold the vacuum jacketed tube or the pipe surrounded by the tubular structure, depending on the practical mechanical design of the terminal, when the temperature of the delivered fluid is higher or lower enough. Of course, any connector whose each terminal having one and only one sealing surface and being made of material whose thermal shrinkage and thermal expansion are larger and smaller than the thermal shrinkage and the thermal expansion of the material used by the vacuum jacketed tube or the pipe surrounded by the tubular structure is acceptable. Beside, to avoid any unnecessary accident, one more option is to position and fix the interconnection of two or more vacuum jacketed tubes inside a manifold box that has a body, one or more opening and a bracket. In such situation, different vacuum jacketed tubes pass through different openings respectively, and the bracket is positioned on the inner surface of a side of the manifold box and the connector is fixed on the bracket.

### BRIEF DESCRIPTION OF THE DRAWINGS

FIG. 1A to FIG. 1C are the cross-sectional illustration of three embodiments of the vacuum jacketed tube respectively.

FIG. 2A and FIG. 2B are the cross-sectional illustrations of two embodiments of the vacuum jacketed tube.

FIG. 3 briefly illustrates the situation that the vacuum jacketed tube is connected to a moving fluid destination.

FIG. 4A to FIG. 4D are the cross-sectional illustrations of two embodiments of the vacuum jacketed tube.

FIG. 5A to FIG. 5B are the cross-sectional illustrations of two embodiments of the vacuum jacketed tube.

FIG. 6A to FIG. 6D are the cross-sectional illustration of an application of the proposed vacuum jacketed tube wherein the fluid delivering path is switchable.

FIG. 7A and FIG. 7B illustrates two comparisons between a known skill and the proposed vacuum jacketed tube respectively.

FIG. 8A to FIG. 8F briefly illustrate some optional designs of the proposed vacuum jacketed tube.

### DETAILED DESCRIPTION OF THE INVENTION

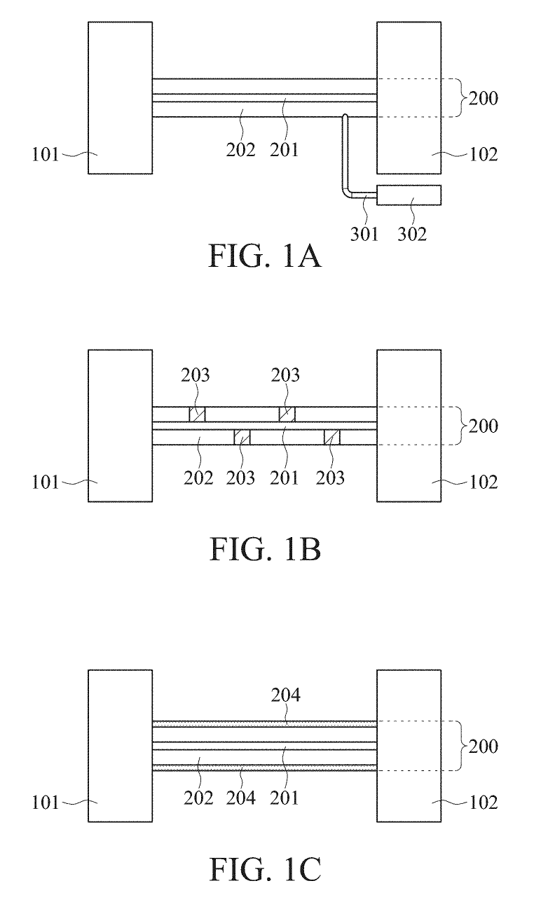

One embodiment of the present invention are shown in FIG. 1A. The proposed vacuum jacketed tube 200 includes at least a pipe 201 and a tubular structure 202, wherein the tubular structure 202 surrounds (or viewed as encloses) the pipe 201 and the fluid is delivered through the inner space of the pipe 201. The proposed vacuum jacketed tube 200 is used to connect the fluid source 101 and the fluid destination 102 so that the fluid may be properly delivered. Moreover, a pumping line 301 connects with a pump 302 may be used to evacuate the space between the tubular structure 202 and the pipe 201 so that this space may be vacuumed or nearly vacuumed. Alternatively, the space between the tubular structure 202 and the pipe 201 also may be evacuated to be vacuum or nearly vacuum before the vacuum jacketed tube 200 is used to connect the fluid source 101 with the fluid destination 102. Therefore, because the efficiency of the heat radiation is significantly lower than both the heat conduction and the heat exchange, the heat exchange between the delivered fluid inside pipe 201 and the external environment outside tubular structure 202 may be significantly decreased due to the vacuumed space. To minimize the heat transfer therebetween, it is optional to physically separate the tubular structure 202 from the pipe 201 although the distance between the pipe 201 and the tubular structure 202 along the radical direction of the vacuum jacketed tube 200 is not particularly limited, and also is optional to reduce the heat transfer (such as heat conduction) between the pipe 201 and the tubular structure 202 by inserting one or more thermal insulate structures 203 (which also may be used to keep the pipe 201 away the tubular structure 202) therebetween, as shown in FIG. 1B. For minimizing the heat transfer therebetween, as shown in 1C, it is further optional to position a thermal-isolated insulate cover 204 outside and surrounding the tubular structure 202, wherein the thermal-isolated insulate cover 204 may be aluminum tape, aluminum foil tape, glass fiber, thermal casing, or any other equivalents. Besides, the details of the pipe 201 and the tubular structure 202 are not strictly limited. Just for example, the pipe 201 may be made of Teflon, Polytetrafluoroethylene, thermal insulator, plastic or rubber, and the tubular structure 202 may be made of stainless steel, iron, aluminum, copper, Teflon, Polytetrafluoroethylene, thermal insulator, plastic, rubber and any combination thereof. The benefit of such material choice is that the pipe 201 may be more adaptive to the high or low temperature of the delivered fluid and the tubular structure 202 may have enough mechanical strength and/or enough thermal insulation, also the finite elasticity of such material allows both the pipe 201 and the tubular structure 202 being somehow flexible/adaptable to maintain the vacuumed space between the pipe 201 and the tubular structure 202 even if the vacuum jacketed tube is extended, compressed, bended or deformed during the fluid delivering period. Furthermore, the details of the fluid source 101, the fluid destination 102, the pumping line 301 and the pump 302 are not limited, too. For example, the pump 302 may also evacuate a portion of the fluid destination 102. For example, the pump 302 may be the different pump or the turbo pump configured to evacuate the process chamber where the wafer is processed (i.e., the fluid destination 102 is located inside the process chamber).

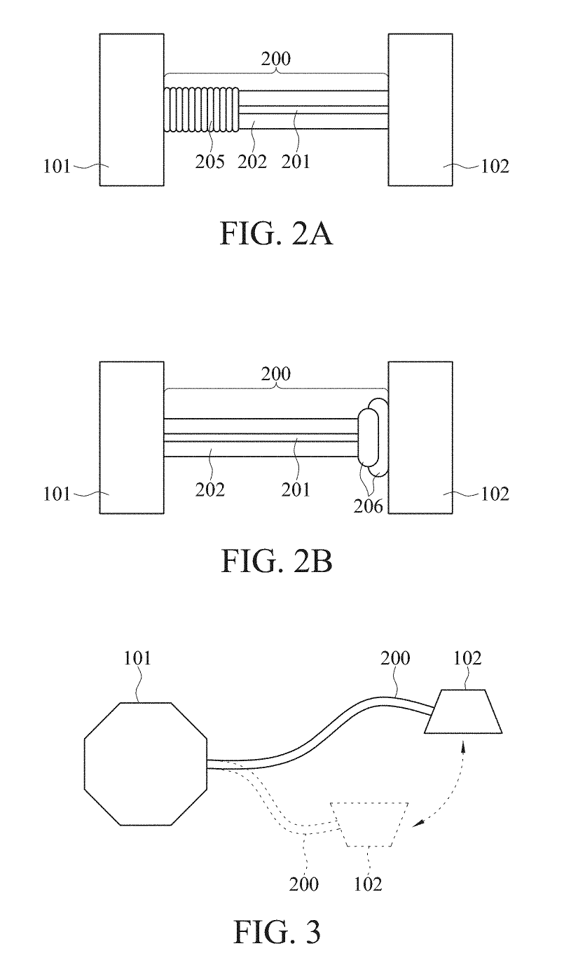

Two more embodiments of the vacuum jacketed tube 200 are shown in FIG. 2A and FIG. 2B respectively. As shown in FIG. 2A, the tubular structure 202 is mechanically connected to the fluid source 101 (or the fluid destination 102 although not illustrated herein) through a bellows 205. Since the bellows 205 is extendable or retractable, the length of the vacuum jacketed tube 200 is correspondingly extended or retracted if the fluid source 101 is moved during the period of delivering fluid. Depending on the practical designs of the bellows 205, the vacuum jacketed tube 200 even may be slight rotated around its own axis. As shown in FIG. 2B, the tubular structure 202 is mechanically connected to the fluid destination 102 (or the fluid source 101 although not illustrated herein) through a rotary joint 206. Since the rotary joint 206 is rotatable and air-tight, the vacuum jacketed tube 200 may be rotated with respect to the fluid destination 102 if the fluid destination 102 is rotated during the period of delivering fluid. Accordingly, leakage of delivered fluid and/or degradation of the vacuumed space resulting from the motion (no matter movement, rotation, vibration or others) of the fluid source/destination 101/102 may be absorbed or at least minimized by the bellows 205 and/or the rotary joint 206. Note that the details of both the bellows 205 and the rotary joint 206 are not particularly limited, because many commercial bellows and commercial rotary joints are available and the proposed vacuum jacketed tube 200 just uses their mechanical elasticity to adapt the motion of the fluid source/destination 101/102 and to minimize any damage on the pipe 201 and the tubular structure 102. For example, one or more O-rings, retaining rings and/or bearing, may be embedded between the bellows/rotary-joint 205/206 and the tubular structure 202, the fluid source 101 and/or the fluid destination 102 for further sealing the interface therebetween and protecting the vacuum space between the pipe 201 and the tubular structure 202.

Another embodiment of the present invention is shown in FIG. 3. Because the usage of the bellows 205 and rotary joint 206, even because the usage of flexible/adaptable material to form the pipe 201 and the tubular structure 202, not only the length of the vacuum jacketed tube 200 is extendable/retractable but also the vacuum jacketed tube 200 is rotatable with respect to the fluid source/destination 101/102, even the vacuum jacketed tube 200 may be twisted/tilted around its own axis. The corresponding benefit of such flexibility is briefly presented as shown in FIG. 3. During the period of delivering fluid, the fluid destination 102 is moved from a first position to a second position and rotated around the vacuum jacketed tube 200. Correspondingly, the vacuum jacketed tube 200 is shortened and rotated around its own axis so as to ensure the connection between the vacuum jacketed tube 200 and both the fluid source 101 and the fluid destination 102. Of course, although not illustrated herein, the pumping line 301 also may be flexible/adaptable to ensure the space between the tubular structure 202 and the pipe 201 is stably vacuumed while the vacuum jacketed tube 200 is swung in response to the movement of the fluid destination 102. One practical application of such embodiment is the low temperature ion implantation that the chuck holding the wafer has to be continuously moved along a line or over a surface, even to be rotated around, with respect to the ion beam during the implantation period to improve the implantation uniformity. In such situation, the coolant has to be continuously delivered from a chiller to the chuck for maintaining the temperature of wafer below a desired threshold or within a desired range during the implantation process. However, while the coolant is delivered through the vacuum jacketed tube 200, the bellows 205 is extended/compressed to adapt the motion of the chuck and the rotary joint 206 is rotated to adapt the rotation of the chuck (even the two-dimensional movement of the chuck), and then both the pipe 201 and the tubular structure 202 are properly protected. Thus, not only the coolant may be continuously delivered, but also the space between the pipe 201 and the tubular structure 202 may be continuously kept with acceptable vacuum degree. Note that the motion of the chuck unavoidably affect the pipe delivering the coolant from the chiller to the chuck, and then proposed vacuum jacketed tube may be used to protect at least a portion of, even whole of, the pipe. Another practical application of such embodiment is the machines configuration in the clean room. Many process gases are delivered from the tanks outside the factory into the clean room inside the factory. Hence, in the situation of re-arranging the machines in the clean room, the vacuum jacketed tube 200 may effectively adapt the movement of the machines among different positions and/or the different geometric configurations of different machines positioned in the same position without the requirement of significantly re-arranging the pipes connecting the tanks and these machines.

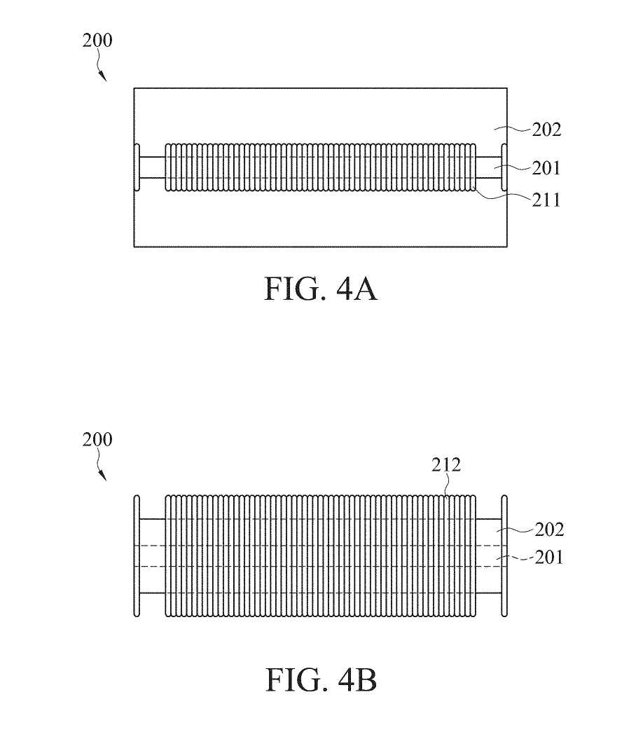

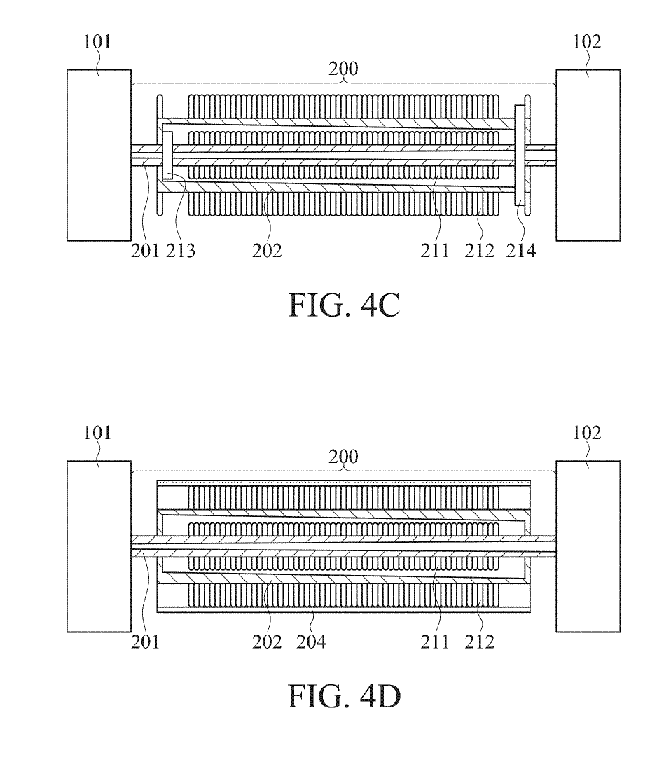

Another two more embodiments of the vacuum jacketed tube 200 are shown in FIG. 4A and FIG. 4B respectively. A set of bellows surrounds at least one of the pipe 201 and the tubular structure 202 to further improve the thermal isolation, even the mechanical strength, of the vacuum jacketed tube. The set of bellows includes the inner bellows 211 and/or the outer bellows 212. The inner bellows 211 is positioned between the tubular structure 202 and the pipe 201 and surrounds the pipe 201, wherein the material of the inner bellows 211 may be Teflon, Polytetrafluoroethylene, plastic, rubber, thermal insulator and any combination thereof. Hence, the thermal isolation of the fluid delivered inside the pipe 201 is further enhanced, because the inner bellows 211 may reduce the probability of directly contact between the pipe 201 and the tubular structure 202 (i.e., reduce the heat conduction therebetween), especially while the inner bellows 211 is made of material with lower heat transfer coefficient. The outer bellows 212 is positioned outside the tubular structure 202 and surrounds the tubular structure 202, wherein the material of the outer bellows 212 may be stainless steel, iron, aluminum, copper, other metal, Teflon, Polytetrafluoroethylene, plastic, rubber, thermal insulator and any combination thereof. Hence, at least the mechanical strength of the vacuum jacketed tube 200 may be enhanced to minimize unexpected accidents, especially if the outer bellows 212 is made of material with higher mechanical strength. Also, the thermal isolation between the delivered fluid and the external environment may be further deduced if the outer bellows 212 is made of material with lower heat transfer coefficient. Note that the outer bellows 212 is separated away the pipe 201 and then the available material of the outer bellows 212 is more flexible. In contrast, because the inner bellows 211 may directly contact with the pipe 201 (or at least is closed to the pipe 201), to effectively reduce the heat transmission, the inner bellows 211 is prefer not made of stainless steel, iron, aluminum, copper, or any other metal. Even the bellows-like shape of the outer bellows 212 may reduce the thermal exchange between the vacuum jacketed tube 200 and the external environment. Note that the size, the sided gap and the winding density of each of the inner bellows 211 and the outer bellows 212 are all not limited. As usual, the inner bellows 211 is separated away the outer bellows 212, except the bending portion of the vacuum jacketed tube 200. Also, as shown in FIG. 4C, optionally, a first clamp 213 is positioned inside the tubular structure 202 and clamps the pipe 201, and a second clamp 214 is positioned outside the tubular structure 202 and clamps the tubular structure 202. The usage of the first clamp 213 and/or the second clamp 214 may fix the inner bellows 211 on the pipe 201 and/or the outer bellows 212 on the tubular structure 202. Also, depending on the positions of the first clamp 213 and/or the second clamp 214, the set of clamps may prevent unexpected and/or un-required bend of the vacuum jacketed tube 200. FIG. 4C illustrates the situation that the first clamp 213 is positioned closed to the interface between the pipe 201 and the fluid source 101 and/or the fluid destination 102 and the second clamp 214 is positioned closed to the interface between the tubular structure 202 and the fluid source 101 and/or the fluid destination 102. In other words, FIG. 4C illustrates the situation that the terminals of the pipe 201 and/or the tubular structure 202 are clamped by the set of clamps to prevent un-expected/un-required bending or deformation of the pipe 201 and/or the tubular structure 202 which will induce the leakage of the delivered fluid and/or the degradation of the vacuum degree in the space between the pipe 201 and the tubular structure 202. The size, such as the width and the thickness of each clamp 213/214 along the axial direction and the radial direction of the vacuum jacketed tube 200 is not particularly limited. In additional, as shown in FIG. 4D, an optional thermal-isolated insulate cover 204 may be positioned outside and surrounds the outer bellows 212 to further enhance the thermal isolation between the delivered fluid inside the vacuum jacketed tube 200 and the external environment. Again, as described above, the thermal-isolated insulate cover 204 may be aluminum tape, aluminum foil tape, glass fiber, thermal casing or other equivalents.

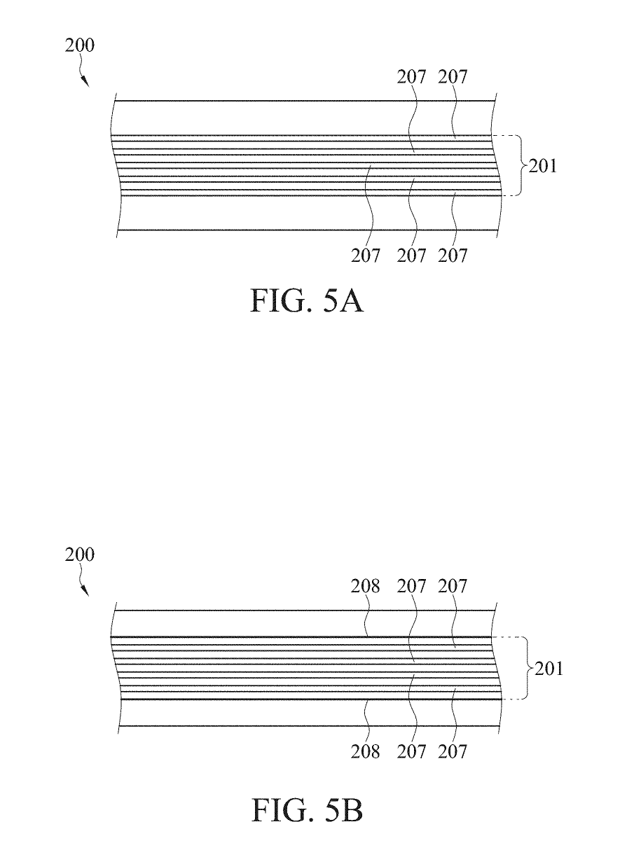

Still two more embodiments of the vacuum jacketed tube 200 are shown in FIG. 5A and FIG. 5B respectively. The pipe 201 may be a single conduit or a combination of two or more conduits. In the latter situation, the pipe 201 may be some conduits 207 directly surrounded by the tubular structure 202, also may be some conduits 207 directly surrounded by the big tube 208 positioned in the space surrounded by the tubular structure 202. Besides different conduits are separated mutually, how the conduits 207 are distributed inside the pipe 201 is not limited. Different conduits 207 may be used to deliver different fluids in the same direction simultaneously, also may be used to deliver same or different fluids in two opposite directions simultaneously. In this way, the vacuum jacketed tube 200 may more flexibly deliver one or more kinds of fluids at the same time. Similar with the material choice of the pipe 201, at least one conduit 207 may be made of material chosen from a group consisting of the following: Teflon, Polytetrafluoroethylene, plastic, rubber, thermal insulator and any combination thereof.

Furthermore, the proposed invention may have many other variations. For example, although not yet particularly illustrated in any figure, both the vacuum valve and the vacuum gauge may be used to adjust how the space between the pipe 201 and the tubular structure 202 is evacuated (i.e., adjusting the pumping rate) and to monitor the vacuum degree in the space therebetween. For example, the vacuum level in the space around the pipe 201 is not particularly limited and is adjustable depending on some factors such as the temperature of the delivered fluid, the flow rate of the delivered fluid, the volume of the space between the pipe 201 and the tubular structure 202, and the material of the pipe 201. For example, how the bellows 205 and the rotary joint 206 (may be viewed as an elastic structure together) are distributed over the vacuum jacketed tube 200 may be flexibly adjusted, although the elastic structure usually is positioned between the fluid source/destination 101/102 and the pipe/tubular structure 201/202.

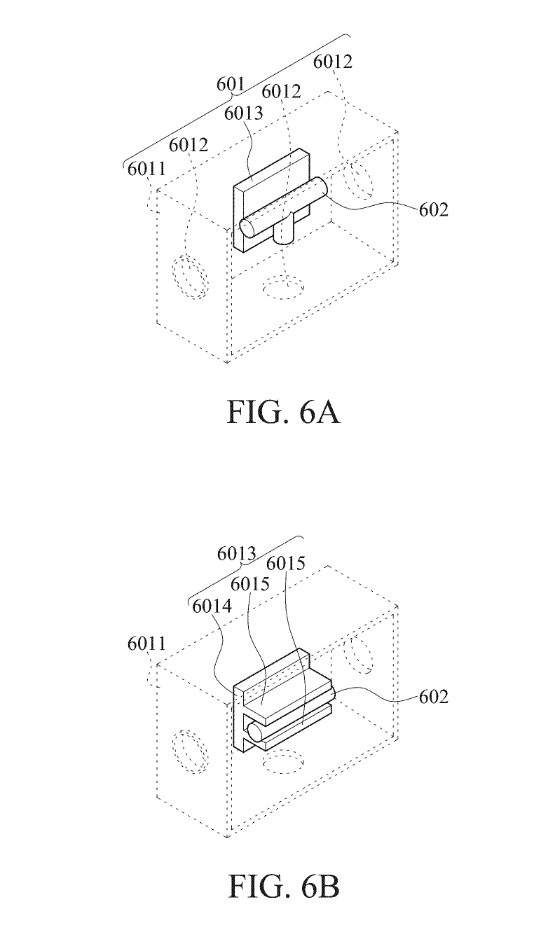

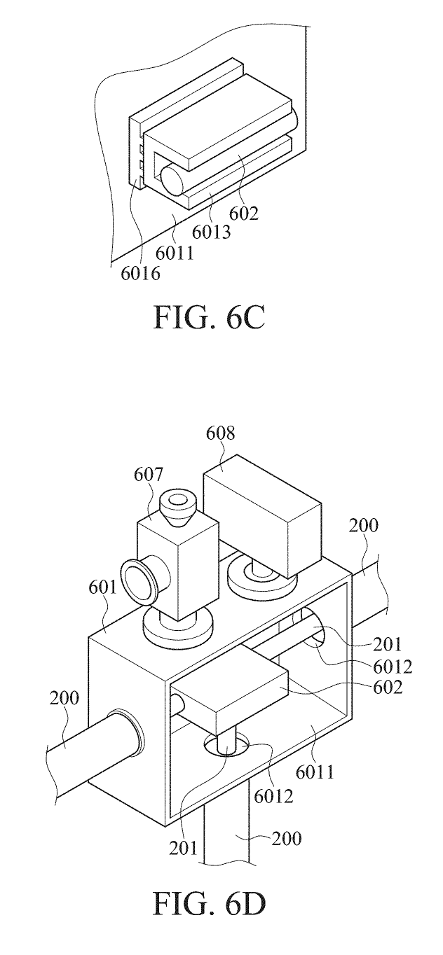

Furthermore, two or more vacuum jacketed tubes 200 may be mechanically connected mutually to flexibly deliver fluid among different fluid sources/destinations 101/102 and/or different fluid paths. One exemplary application is an ion implanter that the wafer may be pre-cooled in the loadlock chamber and cooled in the process chamber during different stages of the ion implantation. Thus, the coolant has to be delivered from a chiller to the loadlock chamber and the process chamber at different times. Therefore, an important challenge is how to ensure these vacuum jacketed tubes 200 are properly connected without leakage of delivered fluid and degradation of vacuum level. Correspondingly, as shown in FIG. 6A and FIG. 6B, some embodiments are related a manifold box 601 where a connector 602 connecting multiple vacuum jacketed tubes 200 is positioned inside to achieve such requirements. To simplify the figures, the vacuum jacketed tube 200 is omitted. The connector 602 is an interconnection of two or more vacuum jacketed tubes 200 and is a structure having a body enclosing a space and two or more terminals embedded in the body. Hence, while different vacuum jacketed tubes 200 are mechanically connected to different terminals respectively, the fluid may be delivered from one vacuum jacketed tube 200 through the enclosed space into one or more other vacuum jacketed tube(s) 200. As shown in figures, the manifold box 601 has a body 6011, one or more opening 6012 and a bracket 6013, wherein different vacuum jacket tubes 202 may pass through different openings 6012 respectively, and wherein the bracket 6013 is positioned on the inner surface of a side of the manifold box 601 and the connector 602 is fixed on the bracket 6013. Thus, each vacuum jacketed tube 200 may be mechanically fixed so that the risk of fluid leaking and/or vacuum broken induced by the vibration and/or thermal expansion/shrinkage of the vacuum jacketed tubes 200 may be minimized. One exemplary and useful bracket 6013 is a combination of a top sub-bracket 6014 and a bottom sub-bracket 6015, wherein the bottom sub-bracket 6015 directly positioned on one inner surface of the manifold box 601 and the top sub-bracket 6014 directly contacted with the bottom sub-bracket 6015, wherein both the top sub-bracket 6014 and the bottom sub-bracket 6015 closely contact the connector 602. Thus, because the bracket 6013 is fixed on the manifold box 601 and the connector 602 is held by bracket 6013, the connector 602 may be protected from damages induced by vibration, collision, thermal expansion, cold shrink or other factors. Optional, as FIG. 6C, a plate 6016 with numerous overhang, such as an overhang array, may be positioned on the inner surface of the body 6011 and the bracket 6013 is directly contacted with the overhang array. Reasonably, the usage of the overhang array may reduce the contact area therebetween and then reduce the heat transferred into or away the fluid delivered inside the vacuum jacketed tube 200 held by the bracket 6013.

Moreover, to ensure the connector 602 may effectively prevent the leakage of the delivered fluid, the connector 602 usually is a connector having the two following features: (1) each terminal having one and only one sealing surface, and (2) each terminal being made of material whose thermal shrinkage and thermal expansion are larger and smaller than the thermal shrinkage and the thermal expansion of the material used to make the vacuum jacketed tube respectively. Surely, depending on the practical design, if the terminal of the connector 602 directly contacts with pipe 201 of the vacuum jacketed tube 200, the material requirement disclosed above directly limits the available material(s) of the pipe 201. Alternatively, if the practical design is that the terminal directly contacts with the tubular structure 202, the material requirement directly limits the available materials of the tubular structure 200. In addition, although not particularly illustrated, each vacuum jacketed tube 200 may further have a valve to adjust the flow rate of the fluid delivered through, wherein the valve may be positioned inside the connecter 602, outside and the connector but inside the manifold box 601, or outside the manifold box 601, depending on the practical mechanical design.

Further, due to the risk of the fluid leakage inside the manifold box 601, as shown in FIG. 6D, the manifold box 601 may additionally have a pump (not particularly illustrated) for evacuate the space enclosed by the body 6011 of the manifold box 601. For example, a vacuum valve 607, such as an angle valve, is combined with a vacuum port 608 attached to the body 6011 of the manifold box 601 for controllably adjusting the pumping rate (i.e., for controllably adjusting the vacuum degree inside the manifold box 601). For example, a vacuum gauge 609, such as a convection gauge, is integrated with the vacuum port 608 or independently attach to the manifold box 601 for continuously and real-time measuring the vacuum degree inside the manifold box 601. Hence, if any delivered fluid is leaked into the manifold box 601, the corresponding vacuum degree variation may be monitored and the leaked fluid may be pumped away immediately, even a warning message may be automatically sent to notice such accident. One advantage of such configuration is that the temperature variation of the delivered fluid inside the vacuum jacketed tube 200 may be monitored immediately because the variation of the vacuum degree unavoidably reduces the heat insulation provided by the vacuum environment. Note that FIG. 6D illustrates the situation that only pipe 201 of vacuum jacketed tube 200 extended into the space enclosed by the body 6011 of the manifold box 601.

One more advantage to use both the manifold box 601 and the connector 602 but not only to use the connector 602 is that the box 6011 surrounding the connector 602 may further prevent the diffusion of the leaked fluid, especially if each opening 6012 is sealed well by using vacuum glue, O-ring, retaining ring or other commercial vacuum isolation technology. Besides, although not particularly illustrated, the clamp also may be used to tie the pipe 201 and/or the tubular structure 202 close to the interface between the vacuum jacketed tube 200 and the manifold box 601 or the connector 602.

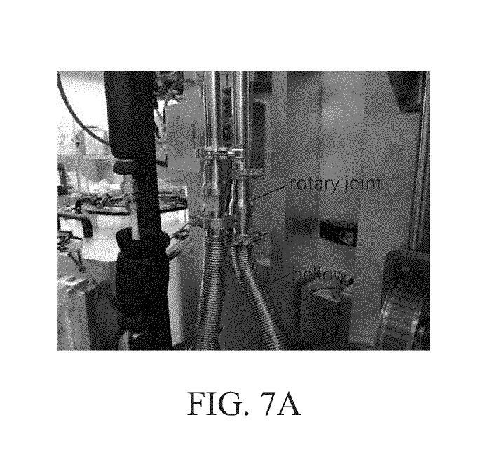

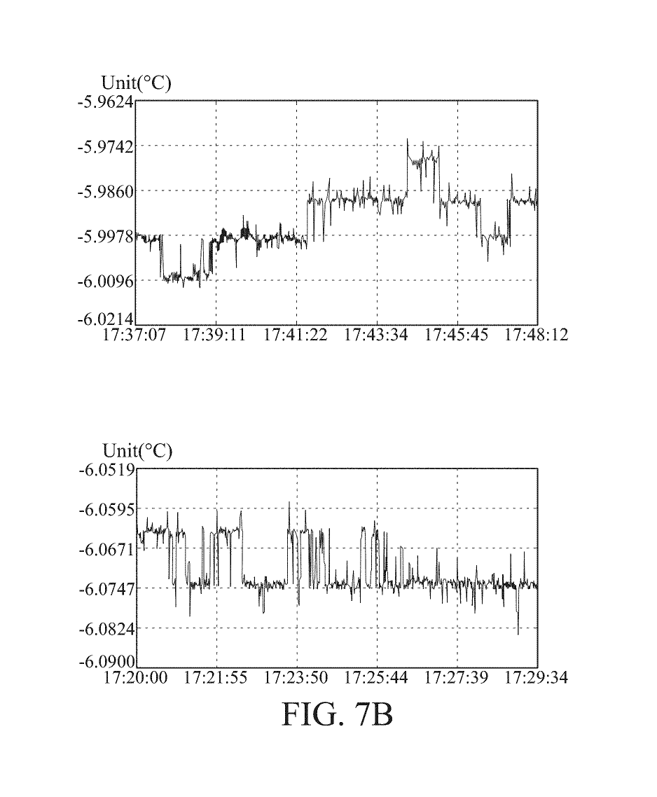

FIG. 7A shows a qualitative comparison between the proposed vacuum jacketed tube and the known skill using the foam/insulator to coat the pipe directly delivering the fluid through its own inner space. In FIG. 7A, the left portion illustrates the known skill where the foam/insulator is black and the right portion illustrates the proposed invention where both the rotary joint and the bellows are labeled. As shown in FIG. 7A, the cross-section diameter is of the proposed vacuum jacketed tube is smaller than that of the known skill. Particularly, as shown in the bottom right portion of FIG. 7A, curved delivering path provided by the proposed vacuum jacketed tube is shown. Accordingly, the proposed vacuum jacketed tube is more suitable for the practical machine design and practical factory configuration, because it occupies less space and is adaptable to the different configurations of different surrounding machines.

FIG. 7B shows a quantitative comparison between the proposed vacuum jacketed tube and the known skill using the foam/insulator to coat the pipe directly delivering the fluid through its own inner space. In FIG. 7B, the left portion and the right portion are the experimental result of the known skill and the proposed vacuum jacketed tube respectively. Clearly, during an essentially period about 10 minutes, the temperature fluctuation by using the know skill is about ten times that of using the proposed vacuum jacketed tube, even the temperature is still significantly fluctuated after ten minutes by using the known skill but the temperature is almost not fluctuated after five minutes by using the proposed vacuum jacketed tube.

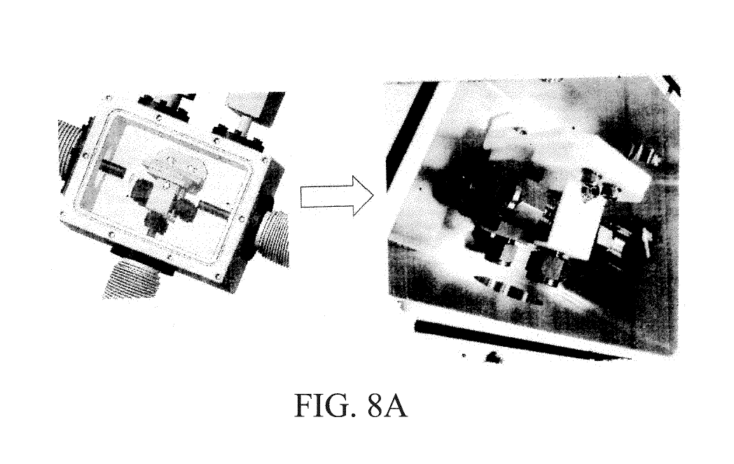

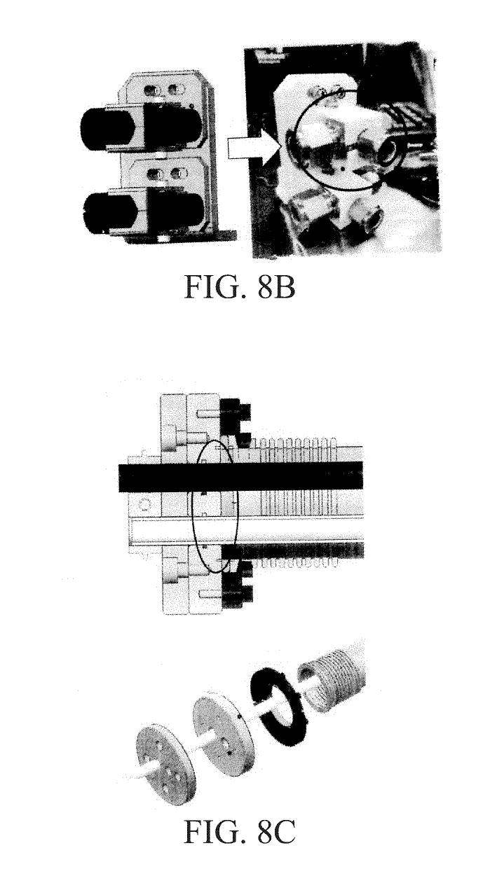

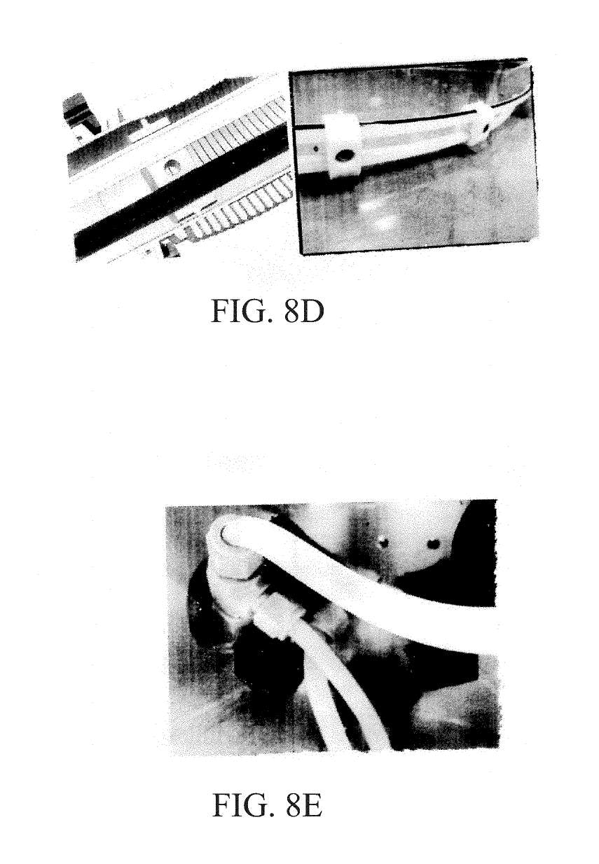

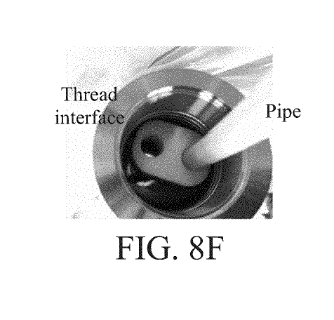

Some optional designs of the proposed vacuum jacketed tube are briefly illustrated below. For example, as shown in FIG. 8A and FIG. 8B, it is optional to use the U shape clamp made of metal material, such as steel, to hold the connector and ensure the function of the connector, especially if the temperature of the delivered fluid is higher or lower enough so that the bracket made of Teflon or other plastic/rubber is weakened, even deformed. For example, as shown in FIG. 8C, to effectively protect the vacuum environment inside the vacuum jacketed tube, double O-ring may be used to seal the pipes. For example, as shown in FIG. 8D, some clamps used to clamp the vacuum jacketed tube may be connected in series to strongly fix and prevent sliding or falling off the pipe. For example, as shown in FIG. 8E, the foam pad is used to provide extra support because the Teflon bracket may be not strong enough if the fluid temperature is extreme or the usage period is longer. For example, as shown in FIG. 8F, the pipe may have threaded interface in its inner surface so that the clamp may be installed inside the bellows to more effectively clamp the pipes. Especially the interference may be positioned close the bellows because the bellows are used to absorb (or behave as a buffer) the variation/deformation induced by the motion/deformation of any hardware connected to or touched to the vacuum jacketed tube.

Variations of the methods, the devices, the systems and the applications as described above may be realized by one skilled in the art. Although the methods, the devices, the systems, and the applications have been described relative to specific embodiments thereof, the invention is not so limited. Many variations in the embodiments described and/or illustrated may be made by those skilled in the art. Accordingly, it will be understood that the present invention is not to be limited to the embodiments disclosed herein, can include practices other than specifically described, and is to be interpreted as broadly as allowed under the law.

What is claimed is:

1. A vacuum jacketed tube, comprising:
a pipe delivering fluid through its inner space;
a tubular structure surrounding the pipe; and
a set of bellows surrounds at least one of the pipe and the tubular structure.

2. The vacuum jacket pipe as claimed in claim 1, further comprising one or more of the following:
the pipe being made of material chosen from a group consisting of the following: Teflon, Polytetrafluoroethylene, plastic, rubber, thermal insulator and any combination thereof; and
the tubular structure being made of material chosen from a group consisting of the following: stainless steel, iron, aluminum, copper, Teflon, Polytetrafluoroethylene, plastic, rubber, thermal insulator and any combination thereof.

3. The vacuum jacketed tube as claimed in claim 1, wherein the set of bellows includes at least one of an inner bellows and an outer bellows.

4. The vacuum jacketed tube as claimed in claim 3, wherein the inner bellows is positioned between the tubular structure and the pipe and surrounds the pipe, and wherein the material of the inner bellows is chosen from a group consisting of Teflon, Polytetrafluoroethylene, plastic, rubber, thermal insulator and any combination thereof.

5. The vacuum jacketed tube as claimed in claim 3, wherein the outer bellows is positioned outside the tubular structure and surrounds the tubular structure, wherein the material of the outer bellows is chosen from a group consisting of the following: stainless steel, iron, aluminum, copper, Teflon, Polytetrafluoroethylene, plastic, rubber, thermal insulator and any combination thereof.

6. The vacuum jacketed tube as claimed in claim 1, further comprising one or more of the following:
a first clamp positioned inside the tubular structure and clamps the pipe; and
a second clamp positioned outside the tubular structure and clamps the tubular structure.

7. The vacuum jacketed tube as claimed in claim 6, further comprising one or more of the following:
the first clamp being positioned closed to the interface between the pipe and the destination and/or the source of the fluid delivered through the pipe; and
the second clamp being positioned closed to the interface between the tubular structure and the destination and/or the source of the fluid delivered through the pipe.

8. The vacuum jacketed tube as claimed in claim 5, further comprising one of the following:
a thermal-isolated insulate cover positioned outside and surrounds the outer bellows; and
a thermal-isolated insulate cover positioned outside and surrounds the tubular structure.

9. The vacuum jacketed tube as claimed in claim 8, wherein the thermal-isolated insulate cover is chosen from a group consisting of the following: aluminum tape, aluminum foil tape, glass fiber, thermal casing and any combination thereof.

10. The vacuum jacketed tube as claimed in claim 1, further comprising one or more of the following:
a vacuum device including at least a vacuum inlet and a pump, wherein one end of the vacuum inlet is positioned in the space between the pipe and the tubular structure and the opposite end of the vacuum inlet is connected with the pump positioned outside the tubular structure;
a vacuum gauge being connected to the tubular structure for monitoring the vacuum degree in the space between the tubular structure and the pipe; and
a vacuum valve being embedded in the vacuum inlet for adjusting the pumping rate through the vacuum inlet.

11. The vacuum jacketed tube as claimed in claim 1, wherein the pipe includes one or more conduits, wherein different conduits are separated respectfully, wherein different conduits is configured to deliver same or different fluids along the axial direction or the reverse axial direction of the pipe respectively, and wherein the material of at least one conduit is chosen from a group consisting of the following: Teflon, plastic, rubber, thermal insulator and any combination thereof.

12. The vacuum jacketed tube as claimed in claim 1, further comprising one or more thermal insulate structures positioned in the space between the pipe and the tubular structure, wherein the thermal insulate structures are configured to separate the pipe away the tubular structure and keep the thermal insulation between the pipe and the tubular structure.

13. The vacuum jacketed tube as claimed in claim 1, wherein two or more vacuum jacketed tubes are connected mutually through the a connector, wherein the connector has a body enclosing an empty inner space and two or more terminals embedded in the body, wherein different vacuum jacketed tubes are mechanically connected to different terminals respectively.

14. The vacuum jacketed tube as claimed in claim 13, wherein each terminal of the connector has one and only one sealing surface and is made of material whose thermal shrinkage and thermal expansion are larger and smaller than the thermal shrinkage and the thermal expansion of the material used to make the pipe respectively.

15. The vacuum jacketed tube as claimed in claim 13, wherein the interconnection of two or more vacuum jacketed tubes are positioned inside a manifold box, wherein the manifold box has a body, one or more opening and a bracket, wherein different vacuum jacket tubes pass through different openings respectively, wherein the bracket is positioned on the inner surface of a side of the manifold box and the connector is fixed on the bracket.

16. The vacuum jacketed tube as claimed in claim 15, wherein the bracket includes a top sub-bracket and a bottom sub-bracket, wherein the bottom sub-bracket is directly positioned on the inner surface and the top sub-bracket is directly contacted with the bottom sub-bracket, wherein the connector is surrounded and held by both the top sub-bracket and the bottom sub-bracket.

17. A vacuum jacketed tube, comprising:
a pipe delivering fluid through its inner space;
a tubular structure surrounding the pipe;
a vacuum device vacuuming the space between the pipe and the tubular structure; and
an elastic structure mechanically contacting with the tubular structure along the axial direction of the vacuum jacketed tube and surrounding the pipe.

18. The vacuum jacketed tube as claimed in claim 17, wherein the elastic structure is chosen from a group consisting of the following:
bellows, rotary joint and combination thereof.

19. The vacuum jacket pipe as claimed in claim 17, further comprising one or more of the following:
the pipe being made of material chosen from a group consisting of the following: Teflon, Polytetrafluoroethylene, plastic, rubber, thermal insulator and any combination thereof; and
the tubular structure being made of material chosen from a group consisting of the following: stainless steel, iron, aluminum, copper, Teflon, Polytetrafluoroethylene, plastic, rubber, thermal insulator and any combination thereof.

20. The vacuum jacketed tube as claimed in claim 17, further comprising one or more of the following:
the vacuum device including at least a vacuum inlet and a pump, wherein one end of the vacuum inlet is positioned in the space between the pipe and the tubular structure and the opposite end of the vacuum inlet is connected with the pump;
a vacuum gauge being connected to the tubular structure for monitoring the vacuum degree in the space between the tubular structure and the pipe; and
a vacuum valve being embedded in the vacuum inlet for adjusting the pumping rate through the vacuum inlet.

21. The vacuum jacketed tube as claimed in claim 17, wherein the pipe includes one or more conduits, wherein different conduits are separated respectfully, wherein different conduits is configured to deliver same or different fluids along the axial direction or the reverse axial direction of the pipe respectively, and wherein at least one conduit is made of material chosen from a group consisting of the following: Teflon, Polytetrafluoroethylene, plastic, rubber, thermal insulator and any combination thereof.

22. The vacuum jacketed tube as claimed in claim 17, further comprising one or more thermal insulate structures positioned in the space between the pipe and the tubular structure, wherein the thermal insulate structures are configured to separate the pipe away the tubular structure and keep the thermal insulation between the pipe and the tubular structure.

23. The vacuum jacketed tube as claimed in claim 17, further comprising a thermal-isolated insulate cover positioned outside and surrounds the tubular structure.

24. The vacuum jacketed tube as claimed in claim 23, wherein the thermal-isolated insulate cover is chosen from a group consisting of the following: aluminum tape, aluminum foil tape, glass fiber, thermal casing and any combination thereof.

25. The vacuum jacketed tube as claimed in claim 17, wherein two or more vacuum jacketed tubes are connected mutually through the a connector, wherein the connector has a body enclosing a space and two or more terminals embedded in the body, wherein different vacuum jacketed tubes are mechanically connected to different terminals respectively.

26. The vacuum jacketed tube as claimed in claim 25, wherein each terminal of the connector is one and only one sealing surface and is made of material whose thermal shrinkage and thermal expansion are larger and smaller than the thermal shrinkage and the thermal expansion of the material used to make the pipe respectively.

27. The vacuum jacketed tube as claimed in claim 25, wherein the interconnection of two or more vacuum jacketed tubes are positioned inside a manifold box, wherein the manifold box has a body, one or more opening and a bracket, wherein different vacuum jacketed tubes pass through different openings respectively, wherein the bracket is positioned on the inner surface of a side of the manifold box and the connector is fixed on the bracket.

28. The vacuum jacketed tube as claimed in claim 27, wherein the bracket includes a top sub-bracket and a bottom sub-bracket, wherein the bottom sub-bracket is directly positioned on the inner surface and the top sub-bracket is directly contacted with the bottom sub-bracket, wherein the connector is surrounded and held by both the top sub-bracket and the bottom sub-bracket.
